(19) United States
(12) Patent Application Publication
(10) Pub. No.: US 2010/0144274 A1
(43) Pub. Date: Jun. 10, 2010

(54) Systems, Methods, and Apparatuses for Determining Proximity Between Computing Apparatuses

(75) Inventors: Ian Mcdowall, Cambridge (GB); Andrew Harker, Herts (GB); Timothy Howes, Cambridge (GB); Marcel de Kogel, Bournemouth (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/634,806

(22) Filed: Dec. 10, 2009

(30) Foreign Application Priority Data
Dec. 10, 2008 (BR) 0822520.3

(51) Int. Cl. H04B 7/00; H04B 17/00; G06F 3/00

(52) U.S. Cl. 455/41.2; 455/67.11; 715/739

(57) ABSTRACT

Methods, apparatuses, and systems are provided for determining proximity between computing apparatuses. A method may include extracting information indicating a transmit signal strength from each of a plurality of electromagnetic transmissions sent by a plurality of second computing apparatuses and received by a first computing apparatus. The method may further include determining received signal strengths of the electromagnetic transmissions. The method may additionally include determining proximities between the first computing apparatus and each of the second computing apparatuses based at least in part upon transmit signal strengths and the received signal strengths. The method may also include generating a list listing the second computing apparatuses and providing an indication of the determined proximities of the second computing apparatuses. Corresponding apparatuses and systems are also provided.

### CROSS-REFERENCE TO RELATED APPLICATIONS

This application claims priority to Great Britain Patent Application No. 0822520.3, filed on 10 Dec. 2008, the contents of which are incorporated herein by reference.

### TECHNOLOGICAL FIELD

Embodiments of the present invention relate generally to communication technology and, more particularly, relate to systems, methods, and apparatuses for determining proximity between computing apparatuses.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer and providing convenience to users.

Current and future networking technologies continue to facilitate ease of information transfer and convenience to users. Several wireless networking technologies facilitate wireless communication between computing apparatuses through the use of electromagnetic transmissions to exchange information between computing apparatuses. One such wireless networking technology is Bluetooth, which may be used to establish personal area networks comprising two or more computing devices located within a sufficient proximity of each other to allow for the exchange of Bluetooth protocol transmissions, which may be limited in effective transmission range.

### BRIEF SUMMARY OF SOME EXAMPLES OF THE INVENTION

Systems, methods, apparatuses, and computer program products are herein provided for determining proximity between computing apparatuses. The systems, methods, apparatuses, and computer program products provided in accordance with embodiments of the invention may provide several advantages to computing devices and computing device users. Some embodiments of the invention determine the proximities between remote computing devices within an effective communication range of a first computing device and the first computing device. Embodiments of the invention use the determined proximities to determine an ordering of remote computing devices within effective communication range based on their respective proximities to the first computing device. Some embodiments of the invention present the ordering of remote computing devices to a user of the first device in the form of an ordered listing displayed on a display.

In some embodiments of the invention, the ordered listing provides a user interface by which a user may view information about remote computing devices within effective communication range of the first computing device and select a remote computing device with which to establish a communication session. In this regard, a user of a first computing device is enabled by such embodiments to determine which of a plurality of remote computing devices within range of transmissions exchanged in accordance with a communications technology is/are closest to the first computing device. As a user may often desire to establish a communication session between the first computing device and a remote computing device that is among the closest, if not the closest, to the first computing device, such ordering may provide the user with information helpful in selecting an available remote computing device with which to establish a communication session. This proximity-based ordering may be particularly useful to the user for selecting a remote computing device with which to establish a communication session (e.g., a target remote computing device) in situations wherein one or more of the remote computing devices within effective communication range are not labeled with device identifiers that are meaningful to the user for distinguishing one potential target device from another.

In a first example embodiment, a method is provided, which comprises extracting information carried by each of a plurality of electromagnetic transmissions sent by a plurality of second computing apparatuses and received by a first computing apparatus. The information carried by a respective electromagnetic transmission of this embodiment comprises a transmit signal strength indicating a signal strength of the respective electromagnetic transmission when the electromagnetic transmission was sent by a respective one of the second computing apparatuses. The method of this embodiment further comprises determining received signal strengths of the electromagnetic transmissions. A received signal strength according to this embodiment indicates a strength of an electromagnetic transmission when received by the first computing apparatus. The method of this embodiment also comprises determining proximities between the first computing apparatus and each of the second computing apparatuses based at least in part upon the transmit signal strengths and the received signal strengths. The method of this embodiment additionally comprises generating a list listing the second computing apparatuses and providing an indication of the determined proximities of the second computing apparatuses.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least extract information carried by each of a plurality of electromagnetic transmissions sent by a plurality of second computing apparatuses and received by the apparatus. The information carried by a respective electromagnetic transmission of this embodiment comprises a transmit signal strength indicating a signal strength of the respective electromagnetic transmission when the electromagnetic transmission was sent by a respective one of the second computing apparatuses. The at least one memory and stored computer program code are configured to, with the at least one processor, further cause the apparatus of this embodiment to determine received signal strengths of the electromagnetic transmissions. A received signal strength according to this embodiment indicates a strength of an electromagnetic transmission when received by the apparatus. The at least one memory and stored computer program code are configured to, with the at least one processor, additionally cause the apparatus of this embodiment to determine proximities between the apparatus and each of the second computing apparatuses based at least in part upon the transmit signal strengths and the received signal strengths. The at least one memory and stored computer program code are configured to, with the at least one processor, further cause the apparatus of this embodiment to generate a list listing the second computing apparatuses and providing an indication of the determined proximities of the second computing apparatuses.

In another example embodiment, a computer program product is provided. The computer program product of this embodiment includes at least one computer-readable storage medium having computer-readable program instructions stored therein. The program instructions of this embodiment comprise program instructions configured to extract information carried by each of a plurality of electromagnetic transmissions sent by a plurality of second computing apparatuses and received by a first computing apparatus. The information carried by a respective electromagnetic transmission of this embodiment comprises a transmit signal strength indicating a signal strength of the respective electromagnetic transmission when the electromagnetic transmission was sent by a respective one of the second computing apparatuses. The program instructions of this embodiment further comprise program instructions configured to determine received signal strengths of the electromagnetic transmissions. A received signal strength according to this embodiment indicates a strength of an electromagnetic transmission when received by the first computing apparatus. The program instructions of this embodiment also comprise program instructions configured to determine proximities between the first computing apparatus and each of the second computing apparatuses based at least in part upon the transmit signal strengths and the received signal strengths. The program instructions of this embodiment additionally comprise program instructions configured to generate a list listing the second computing apparatuses and providing an indication of the determined proximities of the second computing apparatuses.

In another example embodiment, an apparatus is provided that comprises means for extracting information carried by each of a plurality of electromagnetic transmissions sent by a plurality of second computing apparatuses and received by a first computing apparatus. The information carried by a respective electromagnetic transmission of this embodiment comprises a transmit signal strength indicating a signal strength of the respective electromagnetic transmission when the electromagnetic transmission was sent by a respective one of the second computing apparatuses. The apparatus of this embodiment further comprises means for determining received signal strengths of the electromagnetic transmissions. A received signal strength according to this embodiment indicates a strength of an electromagnetic transmission when received by the first computing apparatus. The apparatus of this embodiment also comprises means for determining proximities between the first computing apparatus and each of the second computing apparatuses based at least in part upon the transmit signal strengths and the received signal strengths. The apparatus of this embodiment additionally comprises means for generating a list listing the second computing apparatuses and providing an indication of the determined proximities of the second computing apparatuses.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for determining proximity between computing apparatuses according to an example embodiment of the present invention;

FIG. 2 is a schematic block diagram of a mobile terminal according to an example embodiment of the present invention;

FIG. 3 illustrates a block diagram of an apparatus for determining proximity between computing apparatuses according to an example embodiment of the present invention;

FIG. 4 illustrates an example system in which an example embodiment of the present invention may be implemented;

FIG. 5 illustrates a method for determining proximity between the computing apparatuses of FIG. 4 in accordance with an example embodiment of the invention;

FIG. 6 illustrates an example ordered list of computing apparatuses generated in accordance with an example embodiment of the invention;

FIG. 7 illustrates a flowchart according to an example method for determining proximity between computing apparatuses according to an example embodiment of the invention; and

FIG. 8 illustrates a flowchart according to an example method for determining proximity between computing apparatuses according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

When a user wishes to effect communication between his device and another device using Bluetooth, the user's device must first identify the other device. When there is only one other device in range of the user's device then identification of the other device is a relatively simple operation since the user's device will be able to find only that other device when searching for devices in the vicinity. However, when there is more than one device in range of the user's device, the user's device may identify all devices within range as potential devices with which to establish communication. Given the ubiquity of Bluetooth capable devices, users may frequently encounter a situation when there are several Bluetooth capable devices in range of the user's device, such as, for example, in airports or other crowded public areas. Since a user may generally seek to establish communication with a specific target device or at least avoid establishing communication with an unknown or untrusted device, the user may need to identify the target device from among those within range of the user's device. Identification of the desired target device may be a relatively time-consuming operation, as the user may not be able to derive any meaning from among the devices within range of the user's device. In this regard, the devices within range are often identified in the form of a relatively meaningless series of numbers and/or letters, or a name defined by the owners of the other devices which may also be meaningless to a third party.

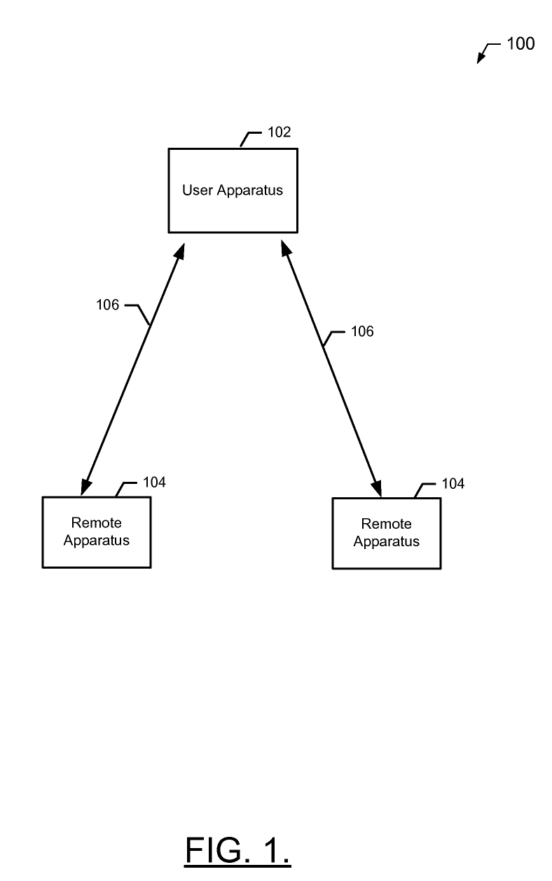

Embodiments of the invention provide systems, methods, apparatuses, and computer program products that may provide meaningful information allowing a user to identify a desired target device when seeking to establish a communication session between two devices. In this regard, FIG. 1 illustrates a block diagram of a system 100 for system for determining proximity between computing apparatuses according to an example embodiment of the present invention. It will be appreciated that the system 100 as well as the illustrations of other figures are each provided as an example of one embodiment of the invention and should not be construed to narrow the scope or spirit of the invention in any way. In this regard, the scope of the invention encompasses many potential embodiments in addition to those illustrated and described herein. As such, while FIG. 1 illustrates one example of a configuration of a system for determining proximity between computing devices, numerous other configurations may also be used to implement embodiments of the present invention.

In at least some embodiments, the system 100 includes a user apparatus 102 and one or more remote apparatuses 104. The user apparatus 102 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, headset, any combination thereof, and/or the like. A remote apparatus 104 may likewise be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, headset, any combination thereof, and/or the like. A remote apparatus 104 may, for example, comprise a second user apparatus 102.

The user apparatus 102 and one or more remote apparatuses 104 are configured in some embodiments to engage in wireless communication using electromagnetic transmissions. These electromagnetic transmissions may comprise any electromagnetic transmission in accordance with a wireless communication technology through which the user apparatus 102 and one or more remote apparatuses 104 are configured to communicate. The electromagnetic transmissions may, for example, comprise transmissions in accordance with a proximity-based communication technology that utilizes range-limited communications to support communication between computing devices within a sufficient proximity of each other to support exchange of the range-limited communications. The proximity-based communication technology may, for example, utilize radio frequency communications.

One example of a proximity-based communication technology is Bluetooth. It will be appreciated, however, that Bluetooth is merely provided as an example of one communication technology through which the user apparatus 102 and one or more remote apparatuses 104 may be configured to engage in communications with each other. Accordingly, where Bluetooth is referenced herein, other proximity-based networking technologies, such as, for example, various Institute of Electrical and Electronics Engineers (IEEE) 802.15 standards, ZigBee, Ultra-Wideband, and/or the like, may be substituted for Bluetooth within the scope of the invention. Further, it will be appreciated, that embodiments of the invention may be used with non-proximity-based communication technologies, such as, for example, IEEE 802.11 networking technologies. Accordingly, it will be further appreciated that wherein Bluetooth technology is referenced herein, non-proximity-based communication technologies may likewise be substituted for Bluetooth within the scope of the invention.

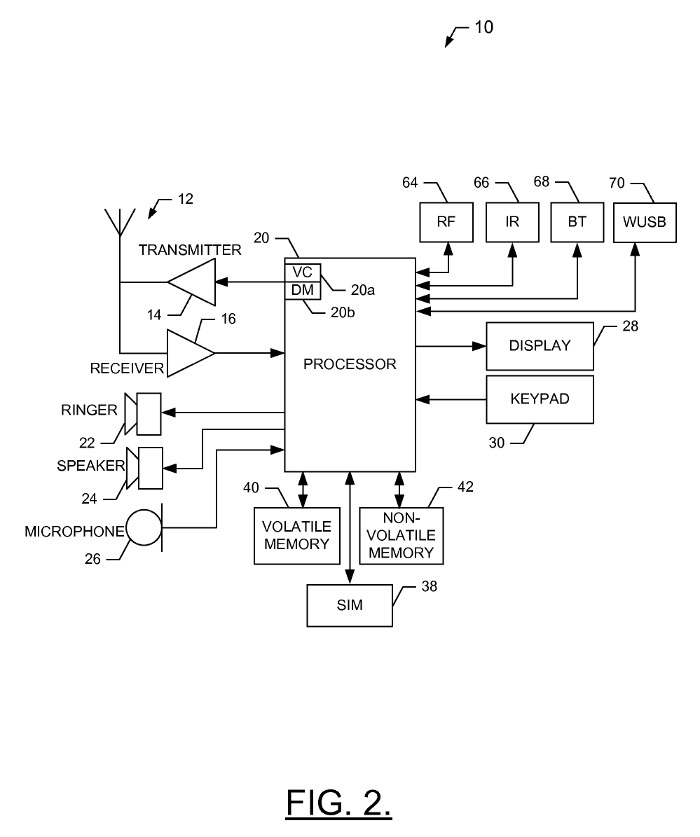

In an example embodiment, the user apparatus 102 and/or one or more remote apparatuses 104 is embodied as a mobile terminal, such as that illustrated in FIG. 2. In this regard, FIG. 2 illustrates a block diagram of a mobile terminal 10 representative of one embodiment of a user apparatus 102 and/or remote apparatus 104 in accordance with embodiments of the present invention. It should be understood, however, that the mobile terminal 10 illustrated and hereinafter described is merely illustrative of one type of user apparatus 102 and/or remote apparatus 104 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

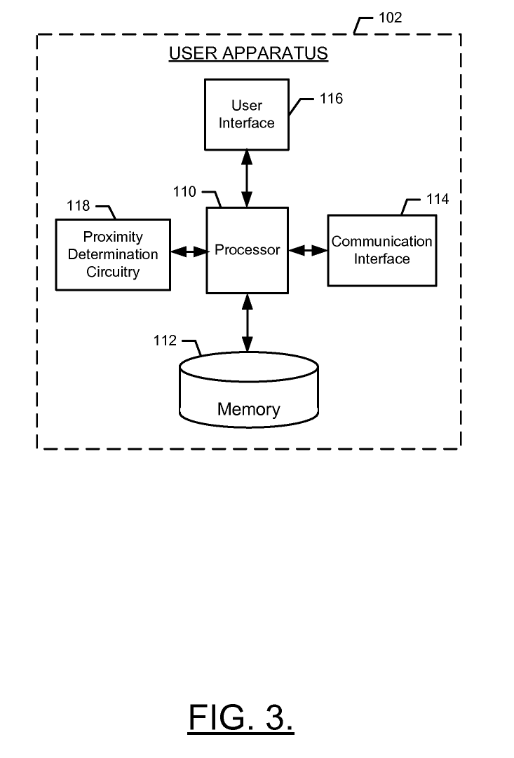

FIG. 3 illustrates a block diagram of a user apparatus 102 for determining proximity between computing apparatuses according to an example embodiment of the present invention. In the example embodiment illustrated in FIG. 3, the user apparatus 102 includes various means, such as a processor 110, memory 112, communication interface 114, user interface 116, and proximity determination circuitry 118 for performing the various functions herein described. These means of the user apparatus 102 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 112) that is executable by a suitably configured processing device (for example, the processor 110), or some combination thereof.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 110 comprises a plurality of processors. The plurality of processors may be in operative communication with each other and may be collectively configured to perform one or more functionalities of the user apparatus 102 as described herein. In embodiments wherein the user apparatus 102 is embodied as a mobile terminal 10, the processor 110 may be embodied as or comprise the processor 20. In an example embodiment, the processor 110 is configured to execute instructions stored in the memory 112 or otherwise accessible to the processor 110. These instructions, when executed by the processor 110, may cause the user apparatus 102 to perform one or more of the functionalities of the user apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. Although illustrated in FIG. 3 as a single memory, the memory 112 may comprise a plurality of memories. In various embodiments, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the user apparatus 102 is embodied as a mobile terminal 10, the memory 112 may comprise the volatile memory 40 and/or the non-volatile memory 42. The memory 112 may be configured to store information, data, applications, instructions, or the like for enabling the user apparatus 102 to carry out various functions in accordance with example embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. This stored information may be stored and/or used by proximity determination circuitry 118 during the course of performing its functionalities.

The communication interface 114 may be embodied as any device or means embodied in circuitry, hardware, a computer program product comprising computer readable program instructions stored on a computer readable medium (for example, the memory 112) and executed by a processing device (for example, the processor 110), or a combination thereof that is configured to receive and/or transmit data from/to an entity of the system 100, such as, for example, a remote apparatus 104. In at least one embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more entities of the system 100. The communication interface 114 may be configured to receive and/or transmit data using any protocol that may be used for communications between entities of the system 100. In this regard, the communication interface 114 may be configured to receive and/or transmit data via electromagnetic transmissions. The electromagnetic transmissions may comprise, for example, radio frequency transmissions, such as, for example, Bluetooth protocol transmissions. In some embodiments, the communication interface 114 comprises a Bluetooth controller. The communication interface 114 may additionally be in communication with the memory 112, user interface 116, and/or proximity determination circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. Accordingly, in some embodiments, the user interface 116 provides a display by which to display a list listing remote apparatuses 104 in an order determined based at least in part on their proximity to the user apparatus 102. The user interface 116 may further provide input means (e.g., one or more keys, a keypad mouse, joystick, touch screen display, and/or the like) to enable a user to select a listed remote apparatus 104 with which to establish a communication session. The user interface 116 may be in communication with the memory 112, communication interface 114, and/or proximity determination circuitry 118, such as via a bus.

The proximity determination circuitry 118 may be embodied as various means, such as circuitry, hardware, a computer program product comprising computer readable program instructions stored on a computer readable medium (for example, the memory 112) and executed by a processing device (for example, the processor 110), or some combination thereof and, in one embodiment, is embodied as or otherwise controlled by the processor 110. In embodiments wherein the proximity determination circuitry 118 is embodied separately from the processor 110, the proximity determination circuitry 118 may be in communication with the processor 110. In some embodiments, the proximity determination circuitry 118 may comprise or be in communication with a Bluetooth controller. The proximity determination circuitry 118 may further be in communication with one or more of the memory 112, communication interface 114, or user interface 116, such as via a bus.

In at least some embodiments, the proximity determination circuitry is configured to extract information carried by an electromagnetic transmission sent by a remote apparatus 104. The electromagnetic transmission may, for example, be received at the user apparatus 102 by the communication interface 114 and passed to the proximity determination circuitry 118 for processing so that the proximity determination circuitry 118 may extract information carried by the received electromagnetic transmission. In some embodiments, the received electromagnetic transmission comprises a Bluetooth protocol transmission. The Bluetooth protocol transmission may, for example, comprise one or more extended inquiry response (EIR) packets.

The information carried by a received electromagnetic transmission may comprise a transmit signal strength indicating a signal strength of the electromagnetic transmission when the electromagnetic transmission was sent by the remote apparatus 104 which transmitted the electromagnetic transmission. In embodiments wherein the electromagnetic transmission comprises a Bluetooth protocol transmission, the transmit signal strength may comprise a transmission power level tag indicating the transmit signal strength of the electromagnetic transmission. The transmission power level tag may be carried, for example, by an EIR packet. Accordingly, by extracting information carried by a received electromagnetic transmission, the proximity determination circuitry 118 may be configured to determine the transmit signal strength of the electromagnetic transmission.

The information carried by a received electromagnetic transmission may further comprise identification information, which may comprise any indication of an identity of a remote apparatus 104 that sent the received transmission. In this regard, the proximity determination circuitry 118 may be configured to identify a remote apparatus 104 that sent a received transmission based on the identification information carried by the transmission. This identification information may be used to distinguish between remote apparatuses 104 when electromagnetic transmissions are received from multiple remote apparatuses 104.

In some embodiments, the proximity determination circuitry 118 is further configured to determine a received signal strength of a received electromagnetic transmission. A received signal strength indicates a strength of an electromagnetic transmission when received by the user apparatus 102. The proximity determination circuitry 118 may be configured to directly determine the received signal strength in embodiments from the received electromagnetic transmission. Additionally or alternatively, the proximity determination circuitry 118 may be configured to determine the received signal strength based at least in part upon an indication of the received signal strength provided to the proximity determination circuitry 118 by the communication interface 114. In this regard, the communication interface 114 may be configured to determine a received signal strength of a received electromagnetic transmission at the point of receipt by the apparatus 102 and provide an indication of the determined received signal strength to the proximity determination circuitry 118. In embodiments wherein the received electromagnetic transmission comprises a Bluetooth protocol transmission, the received signal strength may comprise a Received Signal Strength Indication (RSSI), which may, for example, be provided by a Bluetooth controller in communication with or embodied on one or more of the communication interface 114 or proximity determination circuitry 118.

The proximity determination circuitry 118 is configured in some embodiments to determine a proximity between a remote apparatus 104 from which an electromagnetic transmission was received and the apparatus 102. The proximity determination circuitry 118 may be configured to make this determination based at least in part upon the determined received signal strength and extracted transmit signal strength. In this regard, the proximity determination circuitry 118 may, for example, be configured to calculate a pathloss value by subtracting the received signal strength from the transmit signal strength. Accordingly, the equation for calculating the pathloss value may comprise the following:

pathloss value=transmit signal strength−received signal strength (1)

For example, if the transmit signal strength of a received electromagnetic signal is +6 dBm and the received signal strength of the electromagnetic signal is −60 dBm, the proximity determination circuitry 118 may calculate the pathloss value using equation (1) as:

pathloss value=+6 dBm−(−60 dBm)=+66 dBm

The proximity determination circuitry 118 may be further configured to use a calculated pathloss value to determine a proximity of the user apparatus 102 to the remote apparatus 104 that sent the electromagnetic transmission. For example, the pathloss value may comprise an indication of relative proximity In this regard, the further away that a remote apparatus 104 is from the user apparatus 102, the greater the pathloss value of an electromagnetic transmission received from a remote apparatus 104 is likely to be. Thus, the proximity determination circuitry 118 may be configured to determine the relative proximities of a plurality of remote apparatuses 104 to the user apparatus 102 by determining a relation between the respective pathloss values of electromagnetic transmissions sent by the plurality of remote apparatuses 104. For example, consider an electromagnetic transmission by a first remote apparatus 104 has a pathloss value of +66 dBm as calculated above. Further consider an electromagnetic transmission received by a second remote apparatus 104 having a transmit signal strength of +12 dBm and received signal strength of −40 dBm, yielding a pathloss value of +52 dBm using equation (1). Accordingly, the proximity determination circuitry 118 may determine that the second remote apparatus 104 is closer in proximity to the user apparatus 102 than the first remote apparatus 104 because the pathloss value of the transmission from the second remote apparatus 104 is less than that of the transmission from the first remote apparatus 104. In this regard, remote apparatus 104 having the lower pathloss value is most likely closer in proximity to the user apparatus 102.

Additionally or alternatively, the proximity determination circuitry 118 may be configured to determine an actual, absolute, and/or approximate distance between the user apparatus 102 and a remote apparatus 104 using the pathloss value. In this regard, the proximity determination circuitry 118 may be configured to apply a factor to the pathloss value to determine a distance (e.g., in meters, feet, or other unit of measurement) between the user apparatus 102 and remote apparatus 104. For example, a particular type of electromagnetic transmission may have a known power loss per unit of distance. Accordingly, the proximity determination circuitry 118 may be configured to determine a distance between the user apparatus 102 and a remote apparatus 104 using the pathloss value based on a known power loss per unit of distance for the particular type of electromagnetic transmission received by the user apparatus 102.

It will be appreciated that the proximity determination circuitry 118 may be configured to determine a proximity between the user apparatus 102 and each of a plurality of remote apparatuses 104 from which electromagnetic transmissions were received by the user apparatus 102. The proximity determination circuitry 118 may be configured to generate a list listing the plurality of remote apparatuses 104 from which electromagnetic transmissions have been received and providing an indication of the determined proximities of the remote apparatuses 104.

In one example, the indication of the determined proximities provided by a generated list may comprise listing the remote apparatuses 104 in an order determined based at least in part on the determined proximities. For example, the generated list may list the remote apparatuses 104 in order from the remote apparatus 104 closest in proximity to the user apparatus 102 to the remote apparatus 104 farthest in proximity from the user apparatus 102. Alternatively, the generated list may be in a reverse order such that the remote apparatus 104 farthest from the user apparatus 102 is listed first. The remote apparatuses 104 in the generated list may be identified by respective identification indications carried in electromagnetic transmissions (e.g., Bluetooth device identifications) received by the user apparatus 102.

In another example, the indication provided by the list may comprise displaying proximity indications in conjunction with one or more device identifiers for the remote apparatuses 104. A proximity indication displayed in conjunction with a device identifier may comprise, for example, a determined distance between the user apparatus 102 and the remote apparatus 104 indicated by the device identifier. In another example, proximity may be indicated by displaying one of a plurality of symbols in conjunction with a device identifier. In this regard, each symbol in a set of symbols may represent a certain band of proxmities. For example, a first symbol in the set of symbols may indicate that the remote apparatus 104 is within a band or range of proximity of 0-1 meter, a second symbol may indicate that the remote apparatus 104 is within a band of proximity of 1-3 meters, a third symbol may indicate that the remote apparatus 104 is within a band of proximity of 3-5 meters, and a fourth symbol may indicate that the remote apparatus 104 is more than 5 meters away from the user apparatus 102. It will be appreciated that the example bands are provided merely for purposes of example and the bands may be divided up such that any number of bands or ranges of proximities may be defined. The symbols of the set may comprise, for example, a set of colors, a set of graphics, and/or the like. A graphic may, for example, be displayed adjacent to a device name identifier. A color may, for example, be displayed in a swath adjacent to a device name identifier, used to highlight a device name identifier, used as a font color for the device name identifier, and/or the like. Accordingly, a user may be enabled to determine a proximity of a remote apparatus 104 listed in a generated list even when the list is not ordered based on the determined proximities.

The proximity determination circuitry 118 may be further configured to cause a generated list to be displayed on a display operably connected to the user apparatus 102. Such display may comprise a display of the user interface 116. A user of the user apparatus 102 may then be able to view the listing of remote apparatuses 104 that are within communication range and review the provided indication of their determined proximities. The provided indication may help the user to make a selection of a remote apparatus 104 with which to establish a communications session. Accordingly, the user may select one or more of the listed remote apparatuses 104 using input means provided by the user interface 116. For example, a user may use input means to highlight and/or place a cursor over an indication of a remote apparatus 104 listed in a displayed list and press a key in order to select the remote apparatus 104. In another example, the display on which the list is displayed may comprise a touch screen display and the user may be able to select an indication of a remote apparatus 104 displayed in the list by interacting with the touch screen display (e.g., with a tap or other touch input) at a position overlying the displayed indication.

The proximity determination circuitry 118 may be configured to determine such a selection. In response to the selection, the proximity determination circuitry 118 may be further configured to direct establishment of a communication session between the user apparatus 102 and the one or more selected remote apparatuses 104. The communication session may, for example, comprise “bonding” or “pairing” the user apparatus 102 and the one or more selected remote apparatuses 104. Such “bonding” or “pairing” may, for example, be in accordance with Bluetooth protocol.

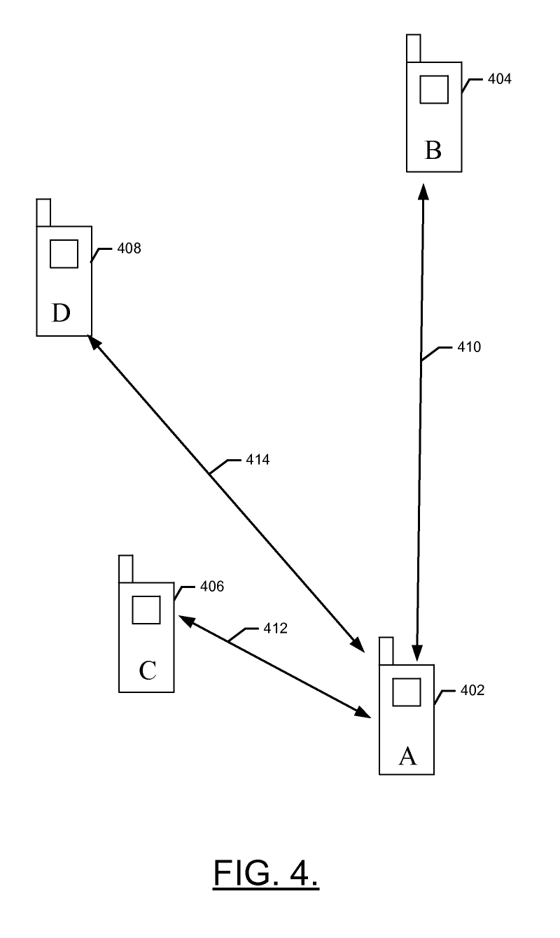

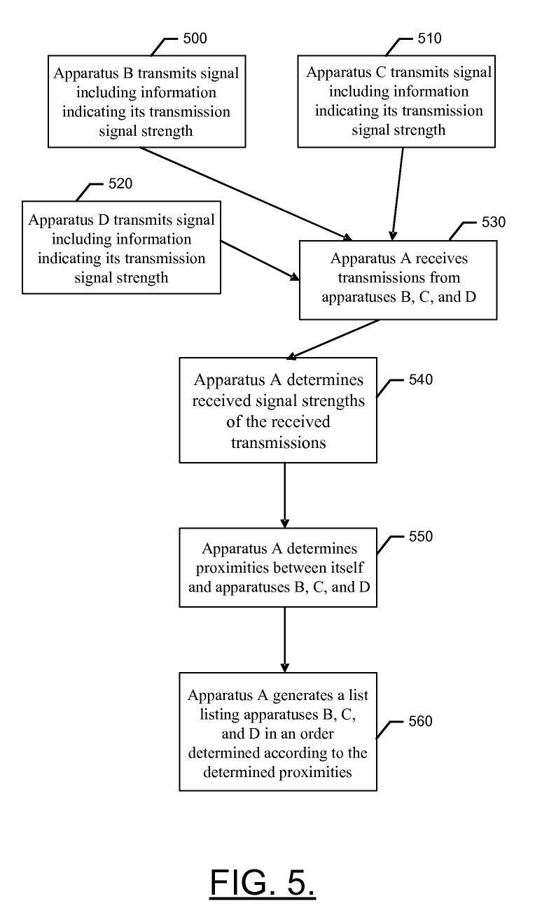

Operation of an example embodiment of the invention will now be described with respect to FIGS. 4-6. Referring to FIG. 4, FIG. 4 illustrates an example system in which an example embodiment of the present invention may be implemented. FIG. 5 corresponds to FIG. 4 and illustrates a method for determining proximity between the computing apparatuses of FIG. 4 in accordance with an example embodiment of the invention. The system of FIG. 4 comprises an apparatus A 402, which may comprise a user apparatus 102. The system of FIG. 4 further comprises apparatuses B 404, C 406, and D 408, which may comprise remote apparatuses 104.

As illustrated in FIGS. 4 and 5, the apparatus B 404 has transmitted the electromagnetic transmission 410 to apparatus A 402 (operation 500); apparatus C 406 has transmitted the electromagnetic transmission 412 to apparatus A 402 (operation 510); and apparatus D 408 has transmitted the electromagnetic transmission 414 to apparatus A 402 (operation 520). The electromagnetic transmissions of operations 500-520 may be transmitted concurrently, at non-overlapping discrete times, or such that two or more of the transmissions at least partially overlap in time during their transmissions. Further, the transmissions of operations 500-520 may occur in any order. At operation 530, the apparatus A 402 receives the electromagnetic transmissions from apparatuses B 404, C 406, and D 408. Each received electromagnetic transmission may include an indication of its respective transmit signal strength as well as identification information (e.g., a device name) enabling the apparatus which sent the transmission to be distinguished from the other apparatuses.

Operation 540 comprises the apparatus A 402 (e.g., the proximity determination circuitry 118) determining the received signal strengths of the received electromagnetic transmissions. Apparatus A 402 (e.g., the proximity determination circuitry 118) then determines proximities between itself and apparatuses B 404, C 406, and D 408 using the transmit signal strengths and received signal strengths, at operation 550. Operation 560 comprises apparatus A 402 (e.g., the proximity determination circuitry 118) generating a list listing apparatuses B, C, and D in an order determined according to the determined proximities.

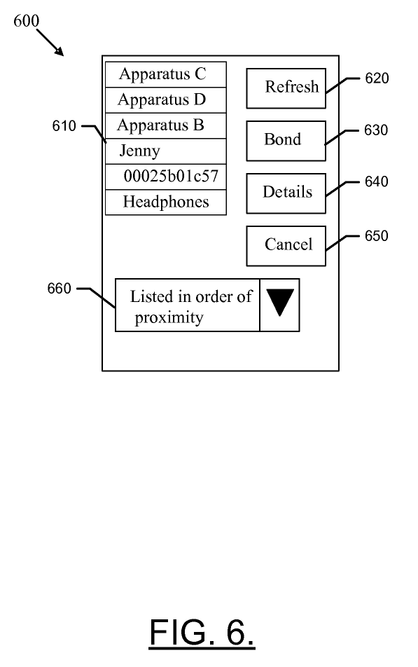

The generated list may be displayed on a display. An example of such a displayed list generated based on the system of FIG. 4 is illustrated in FIG. 6. It will be appreciated that graphical user interface 600 of FIG. 6 is provided merely for purposes of example and the selection and arrangement of elements in FIG. 6 is merely for purposes of example and not by way of limitation. The graphical user interface 600 comprises a list 610 of remote apparatuses listed by name. These listed apparatuses are ordered in the list 610 based on their determined proximities to the apparatus A 402. In this regard, apparatus C 406 has been determined to be closest in proximity, followed by apparatus D 408, and apparatus B 404. Any apparatus listed in the list 610 may be selected using various user input means, such as described above. The graphical user interface 600 also includes “buttons” for refreshing the list 620 (e.g., in case a remote apparatus has come within effective communication range, exited effective communication range, changed proximity relative to another remote apparatus, and/or the like), selecting the bonding process 630 with an apparatus selected in the list 610 (e.g., selecting the process for establishing a communication session with an apparatus selected from the list 610), a “Details” “button” 640 for obtaining more details of a selected apparatus, and a “Cancel” “button” 650. The graphical user interface 600 may further include a drop-down list 660 whereby the format (e.g., ordering) of the list may be chosen. The format shown is “listed in order of proximity ” However, it will be appreciated that other formats, such as, for example, reverse order of proximity, alphabetical order, and/or the like are also options within the scope of the invention.

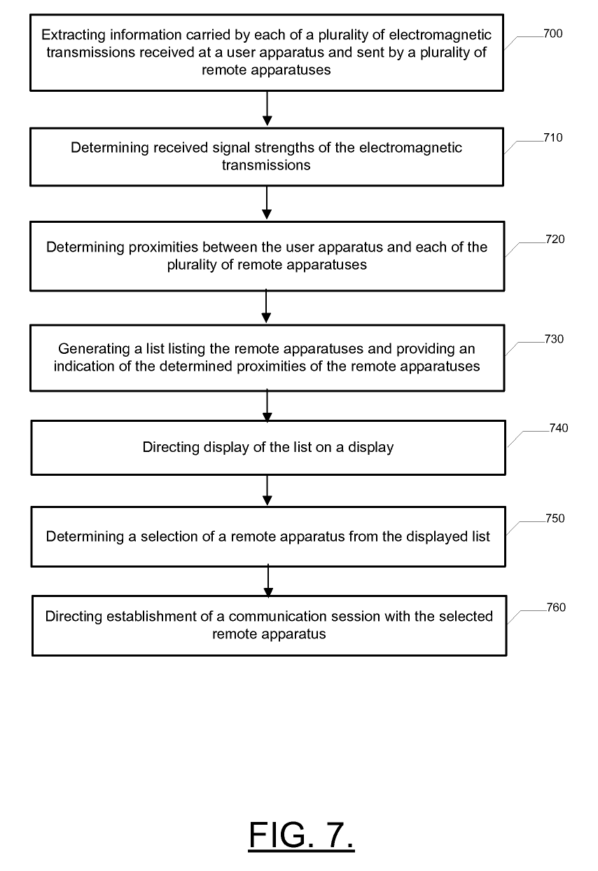

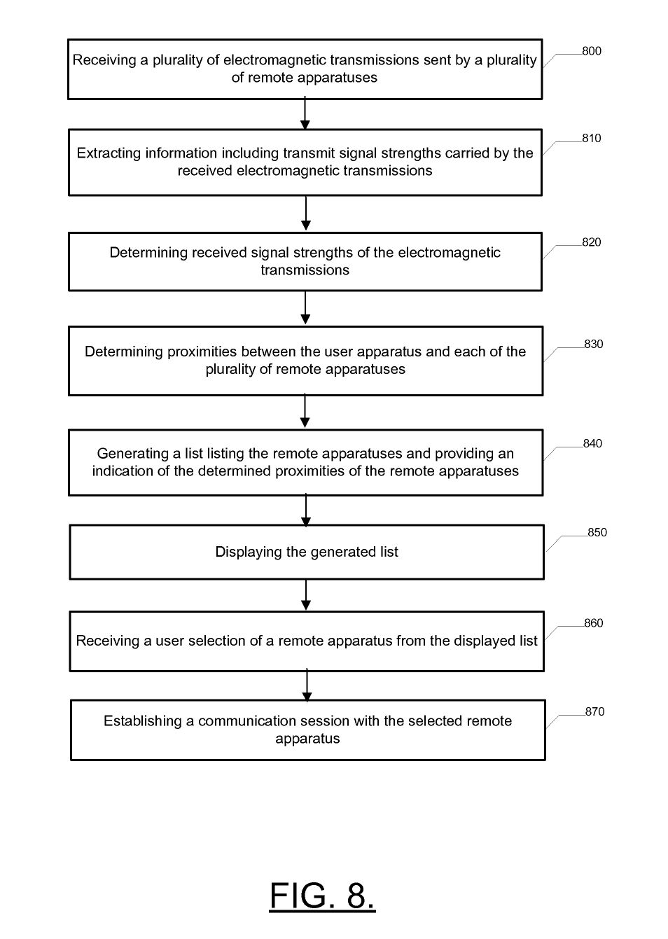

FIG. 7 illustrates a flowchart according to an example method for determining proximity between computing apparatuses according to an example embodiment of the invention. In this regard, FIG. 7 illustrates operations that may, for example, be performed at the user apparatus 102. The operations illustrated and described with respect to FIG. 8 may, for example, be performed by and/or under control of the proximity determination circuitry 118. Operation 700 may comprise extracting information carried by each of a plurality of electromagnetic transmissions received at a user apparatus 102 and sent by a plurality of remote apparatuses 104. The extracted information may comprise transmit signal strengths for the electromagnetic transmissions. Operation 710 may comprise determining received signal strengths of the electromagnetic transmissions. Operation 720 may comprise determining proximities between the user apparatus 102 and each of the plurality of remote apparatuses 104. The determination of operation 720 may be made using the transmit signal strengths and received signal strengths. Operation 730 may comprise generating a list listing the remote apparatuses 104 and providing an indication of the determined proximities of the remote apparatuses 104. Operation 740 may comprise directing display of the generated list on a display. Operation 750 may comprise determining a selection of a remote apparatus 104 from the displayed list. Operation 760 may comprise directing establishment of a communication session with the selected remote apparatus 104. In this regard, a communication session may be established between the user apparatus 102 and selected remote apparatus 104.

It will be appreciated that the operations illustrated in FIG. 7 are not necessarily discrete operations and two or more operations may occur concurrently. Thus, for example, a received signal strength may be determined for a first received electromagnetic transmission while information is being extracted from a second received electromagnetic transmission. Further, it will be appreciated that the ordering of operations in FIG. 7 is by way of example and not by way of limitation. Thus, for example, operation 710 may occur prior to operation 700.

FIG. 8 illustrates a flowchart according to an example method for determining proximity between computing apparatuses according to an example embodiment of the invention. In this regard, FIG. 8 illustrates operations that may, for example, be performed at the user apparatus 102. The operations illustrated and described with respect to FIG. 8 may, for example, be performed by and/or under control of one or more of the processor 110, communication interface 114, user interface 116, or the proximity determination circuitry 118. Operation 800 may comprise receiving a plurality of electromagnetic transmissions sent by a plurality of remote apparatuses 104. Operation 810 may comprise extracting information including transmit signal strengths carried by the received electromagnetic transmissions. Operation 820 may comprise determining received signal strengths of the electromagnetic transmissions. Operation 830 may comprise determining proximities between the user apparatus 102 and each of the plurality of remote apparatuses 104. The determination of operation 830 may be made using the transmit signal strengths and received signal strengths. Operation 840 may comprise generating a list listing the remote apparatuses 104 and providing an indication of the determined proximities of the remote apparatuses 104. Operation 850 may comprise displaying the generated list on a display. Operation 860 may comprise receiving a user selection of a remote apparatus 104 from the displayed list. Operation 870 may comprise establishing a communication session with the selected remote apparatus 104. In this regard, a communication session may be established between the user apparatus 102 and selected remote apparatus 104.

It will be appreciated that the operations illustrated in FIG. 8 are not necessarily discrete operations and two or more operations may occur concurrently. Thus, for example, a received signal strength may be determined for a first received electromagnetic transmission while information is being extracted from a second received electromagnetic transmission. Further, it will be appreciated that the ordering of operations in FIG. 8 is by way of example and not by way of limitation. Thus, for example, operation 820 may occur prior to operation 810.

FIGS. 5 and 7-8 are flowcharts of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, a user apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing devices and computing device users. Some embodiments of the invention determine the proximities between remote computing devices within an effective communication range of a first computing device and the first computing device. Embodiments of the invention use the determined proximities to determine an ordering of remote computing devices within effective communication range based on their respective proximities to the first computing device. Some embodiments of the invention present the ordering of remote computing devices to a user of the first device in the form of an ordered listing displayed on a display.

In some embodiments of the invention, the ordered listing provides a user interface by which a user may view information about remote computing devices within effective communication range of the first computing device and select a remote computing device with which to establish a communication session. In this regard, a user of a first computing device is enabled by such embodiments to determine which of a plurality of remote computing devices within range of transmissions exchanged in accordance with a communications technology is/are closest to the first computing device. As a user may often desire to establish a communication session between the first computing device and a remote computing device that is among the closest, if not the closest, to the first computing device, such ordering may provide the user with information helpful in selecting an available remote computing device with which to establish a communication session. This proximity-based ordering may be particularly useful to the user for selecting a remote computing device with which to establish a communication session (e.g., a target remote computing device) in situations wherein one or more of the remote computing devices within effective communication range are not labeled with device identifiers that are meaningful to the user for distinguishing one potential target device from another.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
extracting information carried by each of a plurality of electromagnetic transmissions sent by a plurality of second computing apparatuses and received by a first computing apparatus, wherein the information carried by a respective electromagnetic transmission comprises a transmit signal strength indicating a signal strength of the respective electromagnetic transmission when the electromagnetic transmission was sent by a respective one of the second computing apparatuses;
determining received signal strengths of the electromagnetic transmissions, wherein a received signal strength indicates a strength of an electromagnetic transmission when received by the first computing apparatus;
determining, by proximity determination circuitry, proximities between the first computing apparatus and each of the second computing apparatuses based at least in part upon the transmit signal strengths and the received signal strengths; and
generating a list listing the second computing apparatuses and providing an indication of the determined proximities of the second computing apparatuses.

2. The method of claim 1, wherein at least one of the plurality of electromagnetic transmissions comprises a radio frequency transmission.

3. The method of claim 1, wherein at least one of the plurality of electromagnetic transmissions comprises a Bluetooth protocol transmission.

4. The method of claim 3, wherein the Bluetooth protocol transmission comprises an extended inquiry response, and wherein the information carried by the extended inquiry response comprises a transmission power level tag.

5. The method of claim 1, wherein determining a proximity between the first computing apparatus and a respective second computing apparatus comprises calculating a pathloss value by subtracting the received signal strength of the electromagnetic transmission sent by the respective second computing apparatus from the transmit signal strength of the electromagnetic transmission sent by the respective second computing apparatus.

6. The method of claim 1, further comprising directing display of the generated list on a display operably connected to the first computing apparatus.

7. The method of claim 6, further comprising determining a selection of one of the second computing apparatuses from the displayed list for establishment of a communication session therewith.

8. The method of claim 1, wherein generating the list comprises generating a list listing the second computing apparatuses in order from the second computing apparatus having the closest determined proximity to the second computing apparatus having the farthest determined proximity.

9. An apparatus comprising at least one processor and at least one memory storing computer program code, wherein the at least one memory and stored computer program code are configured to, with the at least one processor, cause the apparatus to at least:
extract information carried by each of a plurality of electromagnetic transmissions sent by a plurality of second computing apparatuses and received by the apparatus, wherein the information carried by a respective electromagnetic transmission comprises a transmit signal strength indicating a signal strength of the respective electromagnetic transmission when the electromagnetic transmission was sent by a respective one of the second computing apparatuses;
determine received signal strengths of the electromagnetic transmissions, wherein a received signal strength indicates a strength of an electromagnetic transmission when received by the apparatus;
determine proximities between the apparatus and each of the second computing based at least in part upon the transmit signal strengths and the received signal strengths; and
generate a list listing the second computing apparatuses and providing an indication of the determined proximities of the second computing apparatuses.

10. The apparatus of claim 9, wherein at least one of the plurality of electromagnetic transmissions comprises a radio frequency transmission.

11. The apparatus of claim 9, wherein at least one of the plurality of electromagnetic transmissions comprises a Bluetooth protocol transmission.

12. The apparatus of claim 11, wherein the Bluetooth protocol transmission comprises an extended inquiry response, and wherein the information carried by the extended inquiry response comprises a transmission power level tag.

13. The apparatus of claim 9, wherein the at least one memory and stored computer program code are configured to, with the at least one processor, cause the apparatus to determine a proximity between the apparatus and a respective second computing apparatus by calculating a pathloss value, the pathloss value being calculated by subtracting the received signal strength of the electromagnetic transmission sent by the respective second from the transmit signal strength of the electromagnetic transmission sent by the respective second computing apparatus.

14. The apparatus of claim 9, wherein the at least one memory and stored computer program code are configured to, with the at least one processor, further cause the apparatus to:
direct display of the generated list on a display operably connected to the apparatus.

15. The apparatus of claim 14, wherein the at least one memory and stored computer program code are configured to, with the at least one processor, further cause the apparatus to:
determine a selection of one of the second computing apparatuses from the displayed list for establishment of a communication session therewith.

16. The apparatus of claim 9, wherein the at least one memory and stored computer program code are configured to, with the at least one processor, cause the apparatus to generate the list by generating a list listing the second computing apparatuses in order from the second computing apparatus having the closest determined proximity to the second computing apparatus having the farthest determined proximity.

17. The apparatus of claim 9, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

18. A computer program product comprising at least one computer-readable storage medium having computer-readable program instructions stored therein, the computer-readable program instructions comprising:
program instructions configured to extract information carried by each of a plurality of electromagnetic transmissions sent by a plurality of second computing apparatuses and received by a first computing apparatus, wherein the information carried by a respective electromagnetic transmission comprises a transmit signal strength indicating a signal strength of the respective electromagnetic transmission when the electromagnetic transmission was sent by a respective one of the second computing apparatuses;
program instructions configured to determine received signal strengths of the electromagnetic transmissions, wherein a received signal strength indicates a strength of an electromagnetic transmission when received by the first computing apparatus;
program instructions configured to determine proximities between the first computing apparatus and each of the second computing apparatuses based at least in part upon the transmit signal strengths and the received signal strengths; and
program instructions configured to generate a list listing the second computing apparatuses and providing an indication of the determined proximities of the second computing apparatuses.

19. The computer program product of claim 18, wherein the program instructions configured to determine proximities comprise instructions configured to determine a proximity between the first computing apparatus and a respective second computing apparatus by calculating a pathloss value, the pathloss value being calculated by subtracting the received signal strength of the electromagnetic transmission sent by the respective second computing apparatus from the transmit signal strength of the electromagnetic transmission sent by the respective second computing apparatus.

20. The computer program product of claim 18, further comprising program instructions configured to direct display of the generated list on a display operably connected to the first computing apparatus.
